(19) United States
(12) Patent Application Publication
(10) Pub. No.: US 2025/0108829 A1
(43) Pub. Date: Apr. 3, 2025

(54) VEHICLE MARSHALLING WITH FUSION OF ON-BOARD VEHICLE SENSORS AND INFRASTRUCTURE SENSORS

(71) Applicant: Ford Global Technologies, LLC, Dearborn, MI (US)

(72) Inventors: Mario Anthony Santillo, Canton, MI (US); Yousaf Rahman, Ypsilanti, MI (US); Erol Dogan Sumer, Ann Arbor, MI (US)

(73) Assignee: Ford Global Technologies, LLC, Dearborn, MI (US)

(21) Appl. No.: 18/478,399

(22) Filed: Sep. 29, 2023

(51) Int. Cl. B60W 60/00

(52) U.S. Cl. CPC B60W 60/001; B60W 2420/403; B60W 2420/408; B60W 2420/54; B60W 2556/35; B60W 2556/45; B60W 2710/20; B60W 2720/10; B60W 2720/106

(57) ABSTRACT

A method for marshalling a vehicle includes: receiving signals from a set of infrastructure sensors associated with a vehicle management system; processing the signals from the set of infrastructure sensors and the signals from one or more sensors on-board the vehicle; sending the processed signals to the vehicle as one or more vehicle commands; receiving signals from the one or more sensors on-board the vehicle; and processing the one or more vehicle commands and the signals from the one or more sensors on-board the vehicle to generate new commands that are sent to the vehicle to marshal the vehicle to a location.

### FIELD

The present disclosure relates to marshalling of vehicles. More specifically, the present disclosure relates to marshalling of vehicles with fusion of on-board vehicle sensors and infrastructure sensors.

### BACKGROUND

The statements in this section merely provide background information related to the present disclosure and may not constitute prior art.

With the inclusion of automated vehicle marshalling into the manufacturing end-of-line process, vehicles can automatically maneuver between calibration stations without the aid of a human driver. Sensors mounted in the factory infrastructure provide real-time accurate vehicle localization along with wireless communication between the infrastructure and vehicle for closed-loop control. The infrastructure sensors provide vehicle direct control commands to control movement of the vehicle along a path. The infrastructure sensing system can accurately determine vehicle pose information (for example, x and y location, yaw angle and velocity) and calculate direct control commands to move vehicle along path. Due to possible occlusions around the vehicles, the infrastructure may require many sensors which becomes a scaling challenge in large areas, for example, in outdoor parking lots.

These issues related to the automated marshalling of vehicles are addressed by the present disclosure.

### SUMMARY

This section provides a general summary of the disclosure and is not a comprehensive disclosure of its full scope or all of its features.

In one form of the present disclosure, a method for marshalling a vehicle includes: receiving signals from a set of infrastructure sensors associated with a vehicle management system; processing the signals from the set of infrastructure sensors and the signals from one or more sensors on-board the vehicle; sending the processed signals to the vehicle as one or more vehicle commands; receiving signals from the one or more sensors on-board the vehicle; and processing the one or more vehicle commands and the signals from the one or more sensors on-board the vehicle to generate new commands that are sent to the vehicle to marshal the vehicle to a location.

In variations of this method, which may be implemented individually or in any combination: the one or more vehicle commands and the signals from the one or more sensors on-board the vehicle are processed in the vehicle management system; differences between the vehicle commands and the new commands are sent back to the vehicle management system for reconciliation to generate subsequent vehicle commands; the vehicle executes the subsequent vehicle commands; signals communicated with the vehicle management system comprise wireless signals; the one or more vehicle commands include at least one of rate of change of velocity, velocity, torque and steering of the vehicle; the one or more sensors on-board the vehicle includes at least one of a camera, a lidar, a radar, and an ultrasonic sensor; and the set of infrastructure sensors includes at least one of a camera, a lidar, and a radar.

In another form, a method for marshalling of a vehicle includes: processing one or more vehicle commands based on signals from one or more infrastructure sensors associated with a vehicle management control system; sending the one or more vehicle commands to the vehicle; generating signals from one or more sensors on-board the vehicle; and processing the one or more vehicle commands and the signals from the one or more sensors on-board the vehicle to generate new commands for the vehicle. Differences between the one or more vehicle commands and the new commands are sent by wireless communications to the vehicle management control system for reconciliation to generate subsequent vehicle commands. The vehicle executes the subsequent vehicle commands to marshal the vehicle to a location.

In variations of this method, which may be implemented individually or in any combination: the one or more vehicle commands and the signals from the one or more sensors on-board the vehicle are processed in the vehicle management system; the one or more vehicle commands include at least one of rate of change of velocity, velocity, torque and steering of the vehicle; the one or more sensors on-board the vehicle includes at least one of a camera, a lidar, a radar, and an ultrasonic sensor; and the one or more infrastructure sensors include at least one of a camera, a lidar, and a radar.

In yet another form, a system for marshalling a plurality of vehicles includes: a set of infrastructure sensors associated with a vehicle management system, signals from the set of infrastructure sensors being processed as one or more vehicle commands, and one or more sensors on-board each vehicle of the plurality of vehicles that generate signals. The vehicle management system processes the one or more vehicle commands and the signals from the one or more sensors on-board each vehicle of the plurality of vehicle to generate new commands that are sent to each vehicle to marshal each vehicle to a location.

In variations of this system, which may be implemented individually or in any combination: the new commands are processed in the vehicle management system; each vehicle of the plurality of vehicles executes its own modified commands; the new commands account for dynamic obstacles within a zone; the one or more sensor on-board each vehicle of the plurality of vehicles includes at least one of a camera, a lidar, a radar, and an ultrasonic sensor; the set of infrastructure sensors includes at least one of a camera, a lidar, and a radar; and differences between the vehicle commands and the new commands are sent back to the vehicle management system for reconciliation to generate subsequent vehicle commands, and wherein each vehicle if the plurality of vehicles executes the subsequent vehicle commands.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for marshalling vehicles in accordance with the principles of the present disclosure;

FIG. 2 Illustrates an example vehicle capable of being marshalled by the system shown in FIG. 1 in accordance with the principles of the present disclosure;

FIG. 3 is a block diagram of a system for the marshalling of vehicles in accordance with the principles of the present disclosure;

FIG. 4A is a flow diagram of a process for the automated marshalling of vehicles in accordance with the principles of the present disclosure; and

FIG. 4B is continuation of the flow diagram of FIG. 4A.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure describes a system and method to marshal vehicles, such as distribute low-speed autonomous and semi-autonomous vehicles using a combination of infrastructure (IX) sensor and vehicle sensors such as, for example, cameras, lidar, radar, ultrasonic devices, to enable low-speed autonomous or semi-autonomous movement of the vehicles without a driver. This system is capable of both indoor and outdoor deployment. One or more herein described systems provide for control of the movement of vehicles without the need for drivers using a wireless centralized fleet-management system to route each vehicle's movement at any moment to increase the efficiency to the entire logistics chain.

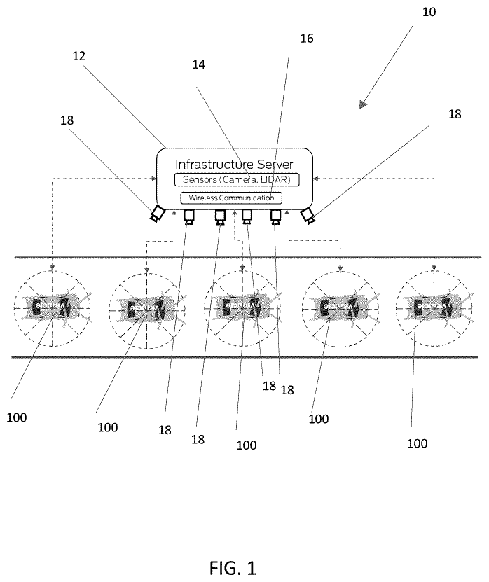

Referring to FIG. 1, there is shown a system 10 for the distribution of vehicles 100, such as autonomous and semi-autonomous vehicles 100 for example, situated in a parking lot. The system 10 includes an IX server 12. The IX server 12 further includes a sensor component 14 that communicates with a set of IX sensors 18 such as, for example, one or more of cameras, lidar, radar, and ultrasonic devices. The IX sensors 18 monitor the movement of the vehicles 100 as they move through, for example, a factory floor or parking lot. The IX server 12 also includes a wireless communication component that provides for communication between the IX server 12 and the vehicles 100.

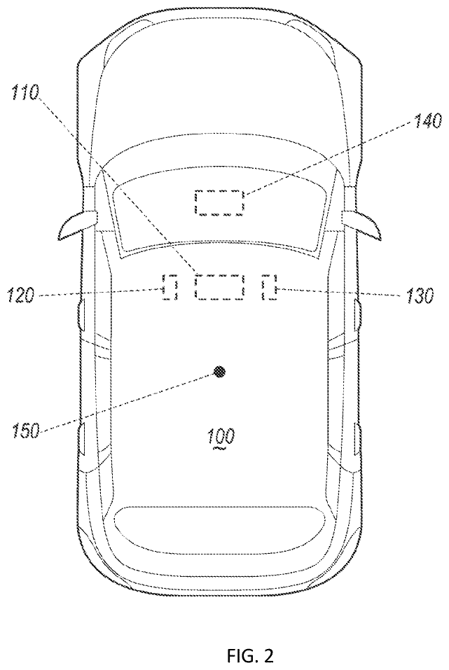

Referring further to FIG. 2, in various forms, the vehicles 100 may be different types of vehicles and powered in a variety of known ways, for example, with an electric motor and/or internal combustion engine. The vehicles 100 may be a land vehicle such as a car, truck, etc., and/or a robot such as drone. The vehicles 100 in some examples include a controller 110, one or more actuators 120, a plurality of sensors 130 on-board the vehicle 100, and a human machine interface (HMI) 140.

The vehicles 100 have a reference point 150, that is, a specified point within the space defined by a vehicle body, for example, a geometrical center point at which respective longitudinal and lateral center axes of the vehicle 100 intersect. The reference point 150 identifies the location of the vehicles, for example, a loading location for the vehicles 100 to be loaded onto a transportation vehicle.

The controller 110 is configured to control operation of the vehicles 100 in an autonomous or a semi-autonomous mode. For purposes of this disclosure, an autonomous mode is defined as one in which each of the vehicle's propulsion and steering are controlled by the controller 110; in a semi-autonomous mode the controller 110 controls one or two of the vehicle's 100 propulsion and/or steering.

The controller 110 includes programming to operate one or more of land vehicle propulsion (for example, control of rate of change of velocity in the vehicle by controlling one or more of an internal combustion engine, electric motor, hybrid engine, etc.), steering, climate control, interior and/or exterior lights, etc., as well as to determine whether and when the controller 110, as opposed to a human operator, is to control such operations. Additionally, the controller 110 is programmed to determine whether and when a human operator is to control such operations.

The controller 110 includes or may be communicatively coupled to (for example, via a vehicle communications bus as described further below) more than one processor, for example, controllers or the like included in the vehicles 100 for monitoring and/or controlling various vehicle controllers, for example, a powertrain controller, a steering controller, etc. The controller 110 is generally arranged for communications on a vehicle communication network that can include a bus in the vehicle 100, such as a controller area network (CAN) or the like, and/or other wired and/or wireless mechanisms.

Via a vehicle network, the controller 110 transmits messages to various devices in the vehicles 100 and/or receives messages from the various devices, for example, an actuator 120, an HMI 140, etc. Alternatively, or additionally, in cases where the controller 110 includes multiple devices, the vehicle communication network is utilized for communications between devices represented as the controller 110 in this disclosure. Further, as mentioned below, various other controllers and/or sensors provide data to the controller 110 via the vehicle communication network.

In addition, the controller 110 is configured for communicating through a wireless vehicular communication interface with other traffic objects (for example, vehicles, IX, pedestrian, etc.), for example, via a vehicle-to-vehicle communication network and/or a vehicle-to-IX communication network, such as communicating using the wireless communication component 16 of the IX server 12. The vehicular communication network represents one or more mechanisms by which the controller 110 of the vehicles 100 communicate with other traffic objects, and may be one or more of wireless communication mechanisms, including any desired combination of wireless (for example, cellular, wireless, satellite, microwave, and radio frequency) communication mechanisms and any desired network topology (or topologies when multiple communication mechanisms are utilized). Examples of vehicular communication networks include cellular, Bluetooth®, IEEE 802.11, dedicated short range communications (DSRC), and/or wide area networks (WAN), including the Internet, providing data communication services.

The vehicle actuators 120 are implemented via circuits, chips, or other electronic and or mechanical components that can actuate various vehicle subsystems in accordance with appropriate control signals. The actuators 120 may be used to control stopping, rate of change of velocity, velocity, torque and steering of the vehicles 100. The controller 110 can be programmed to actuate the vehicle actuators 120 including propulsion, steering, and/or stopping based on the planned rate of change of velocity.

The vehicle sensors 130 include a variety of devices to provide data to the controller 110. For example, the vehicle sensors 130 may include object detection sensors such as lidar sensor(s) disposed on or in the vehicles 100 that provide relative locations, sizes, and shapes of one or more targets surrounding the vehicles 100, for example, second vehicles, bicycles, pedestrians, robots, drones, etc., travelling next to, ahead, or behind of the vehicle. As another example, one or more of the sensors 130 can be radar sensors fixed to vehicles bumpers may provide locations of the target(s) relative to the location of each of the vehicles 100.

The sensors 130 configured as object detection sensors may include a camera sensor, for example, to provide a front view, side view, etc., providing images from an area surrounding the vehicles 100. For example, the controller 110 may be programmed to receive image data from a camera sensor(s) and to implement image processing techniques to detect a road, IX elements, etc. The controller 110 may be further programmed to determine a current vehicle location based on location coordinates, for example, GPS coordinates, received from the vehicle's 100 location from a GPS sensor.

The HMI 140 is configured to receive information from a user, such as a human operator, during operation of the vehicles 100. Moreover, the HMI 140 is configured to present information to the user, such as, an occupant of one or more of the vehicles 100. In some variations, the controller 110 is programmed to receive destination data, for example, location coordinates, from the HMI 140.

Accordingly, the vehicles 100 have advanced driver-assistance system (ADAS) sensors (for example, cameras, radar, ultrasonic, etc.) that can aid in more accurate vehicle localization to enhance reduce the number of sensors that need to be mounted in the infrastructure. Hence, to park the vehicles 100 closely with maximum efficiency, the number of infrastructure sensors required is reduced. For example, the present disclosure describes utilizing on-board sensors to determine more accurately the vehicle location relative to the vehicle in front, behind, or in right/left side to aid in tight parking areas.

Fusing sensor information from on-board vehicle sensors 130 and IX sensors 18 can be challenging. Accordingly, one or more examples of the present disclosure includes sharing raw sensing information of the vehicle sensors 130 and IX sensors 18 across a wireless communication channel. For example, a combination of sensing information from different sources is utilized to control marshalling of the vehicles 100.

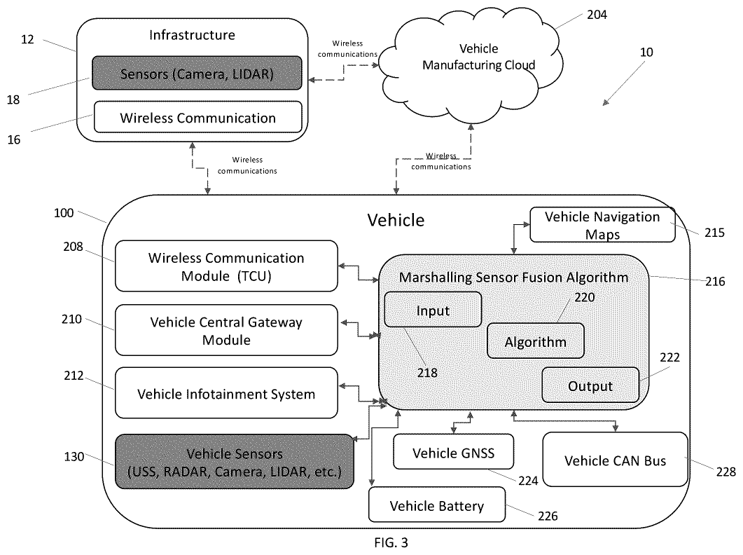

Referring to FIG. 3, there is shown further details of the system 10 for marshalling vehicles by fusing sensor information from the vehicle sensors 130 and the IX sensors 18. The IX server 12 and the vehicle 100 further communicate with a vehicle manufacturing cloud 204 through wireless communications. In addition to the vehicle sensors 130, the vehicle 100 also includes a wireless communication module, such as a telematics control unit (TCU) 208, a vehicle central gateway module 210 and a vehicle infotainment module 210 that communicate with a marshalling sensor fusion algorithm 216 and/or other marshalling controllers.

The marshalling sensor fusion algorithm 216 has a central algorithm 120, an input component 218 and an output component 222. The marshalling sensor fusion algorithm 216 sends and receives signals from a vehicle global navigation satellite system (GNSS) 224, which includes GPS, a vehicle control area network (CAN) bus 228, a vehicle battery 226 and vehicle navigation maps 215, thereby allowing for fusion of sensor data or information.

Accordingly, instead of fusing on-board vehicle sensors 130 and IX sensors 18 at the sensor level (that is, calculating the control actions), the system 10 is configured to utilize the marshalling sensor fusion algorithm 216 to fuse the sensors at the level of the controller 110. Accordingly, the IX server 12 calculates vehicle commands (for example, rate of change of velocity, velocity, torque, and steering) as if it were the only available sensor array and communicates these commands to the vehicle 100 for execution.

Within the controller 110, the vehicle 100 processes both IX based commands as well as information from the on-board sensors 130 to generate process a new command with additional information for the vehicle 100. Any changes to the original command (e.g., a command based on fused sensor data) are communicated back to the IX server 12 for reconciliation, for example, to provide any corresponding updated control operations. When a fleet of vehicles are appropriately equipped with on-board sensors 130, the system 10 is, thus, utilized to efficiently fuse signals from the vehicle on-board sensors 130 and the IX sensors 18.

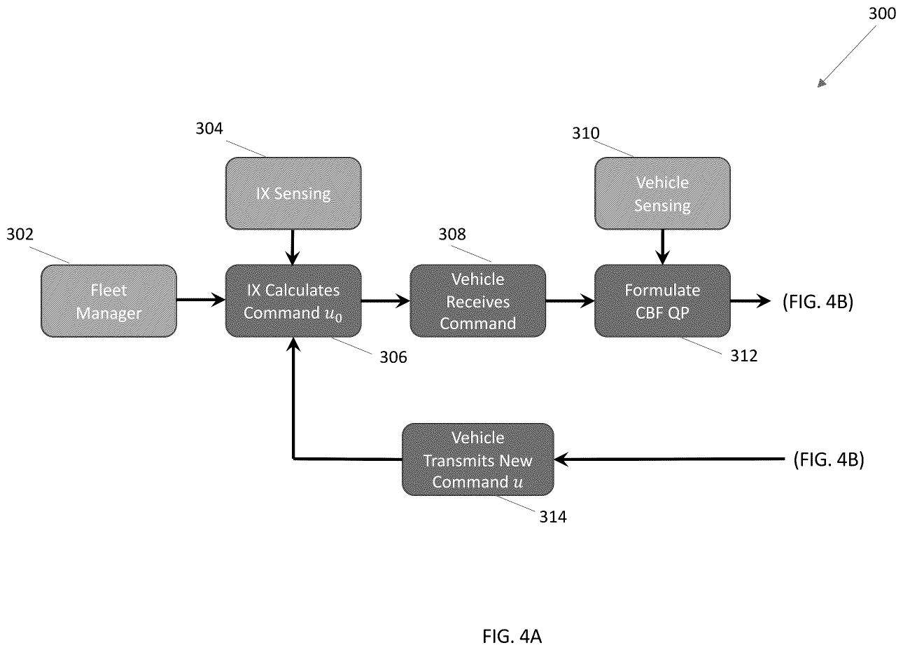

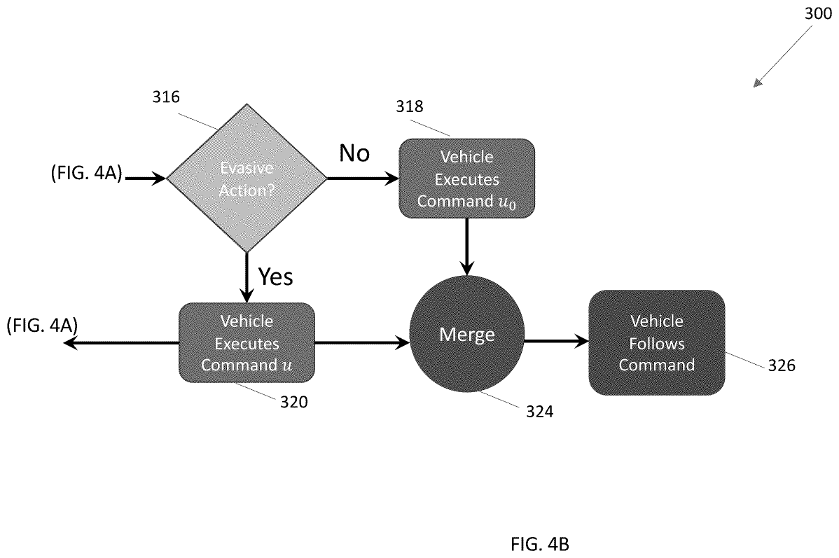

A particular control implementation for the system 10 is shown as a process 300 in FIGS. 4A and 4B. In an operation 306, the IX server 12 calculates initial vehicle commands uₒ based on information received from a vehicle management system (e.g., fleet manager system) at an operation 302 and from an operation 304 that provides information from IX sensors 18. For example, sensor information or data for different sources is obtained or received by the IX server 12. Next, at an operation 308 the vehicle 100 receives one or more vehicle commands that were calculated at operation 306. The process 300 then moves to an operation 312 that receives the vehicle command(s) from the operation 310 (that includes signals from the vehicle sensors 130) and formulates control barrier functions (CBF). For example, the vehicle command(s) are processed to generate CBFs with a determination made at an operation 316 of whether evasive actions are required by the vehicle 100. If a determination is made at the operation 316 that evasive actions are required, the process 300 executes a subsequent vehicle command u in an operation 320 and returns to the operation 314, such that the vehicle command u is transmitted from the vehicle 100 to the IX service 12, which processes the vehicle command at the operation 306. If no evasive actions are required (as determined at operation 316), the process 300 continues to an operation 318 that executes an initial vehicle command uₒ, which is merged with the vehicle command u in an operation 324 (e.g., the merged commands are based on fused sensor data). Then the process 300 moves to an operation 326 in which the vehicle 100 follows the command (e.g., the vehicle is controlled based on one or more new commands based on fused data).

Accordingly, the IX server 12 calculates nominal vehicle commands for all the vehicles 100 within a zone u_{o,i}, where i=1 . . . . N represents each unique vehicle in the zone with N total vehicles in the zone and communicates these commands to each vehicle 100 within that zone. That is, all the vehicles 100 receive the nominal control input for all vehicles within a zone. The controller 110 for each vehicle 100 processes both the IX based nominal control inputs for all the vehicles, as well as data from its own sensors 18, to generate new commands uᵢ for all vehicles that are considered dynamic obstacles within the zone. Each vehicle 100 then executes a corresponding modified command for the particular vehicle 100 (e.g., each vehicle 100 executes its own modified command). In this manner, each vehicle 100 acts as if the vehicle 100 is a centralized controller having knowledge of every surrounding vehicle/object's nominal control command, while executing only its own control commands in various examples. The process 300 may require additional communication bandwidth to each vehicle 100 in some examples, but this can result in increased control coordination throughout the vehicle fleet.

As described above, the process 300 utilizes CBFs that are an algorithmic tool utilized to impose constraints to dynamic systems, such as, for example, \dot{x}=ƒ(x)+g(x)u, where x is the state of the dynamic system and u is the control input for the functions ƒ(x) and g(x). Specifically, a barrier constraint h(x) is expressed as an inequality: h(x)>0. Hence, the state x includes elements of a dynamic model such as vehicle lateral and longitudinal positions, forward velocity, and yaw orientation. The state may additionally include elements of multiple dynamic bicycle models in the case of interacting vehicles.

It should be noted that the operation 312 generates CBFs in such a way that the violation of one or more of the barrier constraints implies that an evasive action must be taken to prevent contact with a first-order barrier constraint given as: \dot{h}(x)+L₀h(x)>0, where L₀ is a configurable parameter.

The operation 312 also formulates a quadratic program (QP) in some examples that is executed in the controller 110 to minimize the difference between the nominal (IX-based) control input u₀ and the vehicle-calculated control input u to prevent contact based on the barrier constraints given by:

$${min}_{u} {‖ u - {u}_{0} ‖}^{2} subject to {L}_{f} h ( x ) + {L}_{g} h ( x ) u + {α}_{h} ( h ( x ) ) \geq 0 ,$$

where L_{ƒ} and L_{g} represent directional derivatives.

In operation, if the vehicle sensors 130 do not indicate any issues with the IX-calculated command u₀, no control modification is needed, and the vehicle executes u₀. If the vehicle sensors 130 indicate that action is required compared to what was calculated from the IX server 12, a new control command is executed that ensures contact-free operation of the vehicle 100. The new control command is additionally communicated back to the IX for inclusion in its future control scheme.

Among other advantages and benefits, the system 10 utilizes non-collocated sensors (that is, the vehicle sensors 130 and the IX sensors 18) at the control algorithm level to prevent high-bandwidth wireless communication and precision timestamping of the data. The system 10 works seamlessly in a heterogeneous fleet of vehicles. The IX-based commands are the primary source of control, and if the vehicle 100 has additional sensors to enhance the efficiency of the marshalling of the vehicle 100, all the sensors can be utilized directly in the CBF formulation. If all the vehicles 100 in a fleet have the vehicle sensors 130 to fuse with the IX sensors 18, the number of IX sensors 18 can be reduced considerably, adding to scalability in large spaces, such as, for example, outdoor parking lots.

Other advantages and benefits include the utilization of vehicle on-board sensors as a second layer of defense to maximize contact-free operation, even if the IX server 12 calculates and communicates an erroneous command, including, for example, variance factors such as wireless communication delay, interference from vulnerable road users, and traffic environment situations. As such, the system 10 considers situations with moving objects, for example, pedestrians, bicyclists, and other vehicles or equipment.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for marshalling a vehicle, the method comprising:
receiving signals from a set of infrastructure sensors associated with a vehicle management system;
processing the signals from the set of infrastructure sensors and the signals from one or more sensors on-board the vehicle;
sending the processed signals to the vehicle as one or more vehicle commands;
receiving signals from the one or more sensors on-board the vehicle; and
processing the one or more vehicle commands and the signals from the one or more sensors on-board the vehicle to generate new commands that are sent to the vehicle to marshall the vehicle to a location.

2. The method of claim 1, wherein the one or more vehicle commands and the signals from the one or more sensors on-board the vehicle are processed in the vehicle management system.

3. The method of claim 1, wherein differences between the vehicle commands and the new commands are sent back to the vehicle management system for reconciliation to generate subsequent vehicle commands.

4. The method of claim 3, wherein the vehicle executes the subsequent vehicle commands.

5. The method of claim 3, wherein signals communicated with the vehicle management system comprise wireless signals.

6. The method of claim 1, wherein the one or more vehicle commands include at least one of rate of change of velocity, velocity, torque and steering of the vehicle.

7. The method of claim 1, wherein the one or more sensors on-board the vehicle includes at least one of a camera, a lidar, a radar, and an ultrasonic sensor.

8. The method of claim 1, wherein the set of infrastructure sensors includes at least one of a camera, a lidar, and a radar.

9. A method for marshalling a vehicle, the method comprising:
processing one or more vehicle commands based on signals from one or more infrastructure sensors associated with a vehicle management control system;
sending the one or more vehicle commands to the vehicle;
generating signals from one or more sensors on-board the vehicle; and
processing the one or more vehicle commands and the signals from the one or more sensors on-board the vehicle to generate new commands for the vehicle,
wherein differences between the one or more vehicle commands and the new commands are sent by wireless communications to the vehicle management control system for reconciliation to generate subsequent vehicle commands, and wherein the vehicle executes the subsequent vehicle commands to marshall the vehicle to a location.

10. The method of claim 9, wherein the one or more vehicle commands and the signals from the one or more sensors on-board the vehicle are processed in the vehicle management system.

11. The method of claim 9 wherein the one or more vehicle commands include at least one of rate of change of velocity, velocity, torque and steering of the vehicle.

12. The method of claim 9, wherein the one or more sensors on-board the vehicle includes at least one of a camera, a lidar, a radar, and an ultrasonic sensor.

13. The method of claim 9, wherein the one or more infrastructure sensors include at least one of a camera, a lidar, and a radar.

14. A system for marshalling a plurality of vehicles, the system comprising:
a set of infrastructure sensors associated with a vehicle management system, signals from the set of infrastructure sensors being processed as one or more vehicle commands; and
one or more sensors on-board each of the plurality of vehicles that generate signals,
wherein the vehicle management system processes the one or more vehicle commands and the signals from one or more sensors on-board each of the plurality of vehicle to generate new commands that are sent to each of the plurality of vehicles to marshal each vehicle to a location.

15. The system of claim 14, wherein the new commands are processed in the vehicle management system.

16. The system of claim 14, wherein each vehicle of the plurality of vehicles executes its own modified commands.

17. The system of claim 14, wherein the new commands account for dynamic obstacles within a zone.

18. The system of claim 14, wherein the one or more sensor on-board each vehicle of the plurality of vehicles includes at least one of a camera, a lidar, a radar, and an ultrasonic sensor.

19. The system of claim 14, wherein the set of infrastructure sensors includes at least one of a camera, a lidar, and a radar.

20. The system of claim 14, wherein differences between the vehicle commands and the new commands are sent back to the vehicle management system for reconciliation to generate subsequent vehicle commands, and wherein each vehicle if the plurality of vehicles executes the subsequent vehicle commands.
